(19) United States
(12) Patent Application Publication
(10) Pub. No.: US 2011/0111184 A1
(43) Pub. Date: May 12, 2011

(54) EDGEBANDING TAPE

(75) Inventors: Vadim Bytensky, Toronto (CA); Anatoly Bortnik, Richmond Hill (CA); Izrail Vainberg, Thornhill (CA)

(73) Assignee: GLOBAL WOOD CONCEPTS LTD., Downsview (CA)

(21) Appl. No.: 12/938,070

(22) Filed: Nov. 2, 2010

(30) Foreign Application Priority Data
Nov. 6, 2009 (CA) 2684769

(51) Int. Cl. B32B 3/02; B29C 65/14; B32B 7/12

(52) U.S. Cl. 428/192; 156/272.6

(57) ABSTRACT

An edgebanding tape comprises a surface activated strip comprising a copolymer of ethylene and acrylic or methacrylic acid having a thickness of 0.5 mm or greater.

### FIELD

The disclosure relates to an edgebanding tape. Specifically, the disclosure relates to an edgebanding tape useable for finishing a board in the manufacture of furniture, a furniture component comprising such an edgebanding tape, and a process for finishing a board in the manufacture of furniture.

### INTRODUCTION

The following is not an admission that anything discussed below is prior art or part of the common general knowledge of persons skilled in the art.

The following summary is provided to introduce the reader to the more detailed discussion to follow. The summary is not intended to limit or define the claims.

PCT Publication No. WO/1995/020633 (Kreckel) discloses a tear-resistant adhesive tape based on monoaxially-oriented polyethylene. Further, a polymeric carrier with a coating of pressure-sensitive adhesive is disclosed.

United States Patent Application Publication No. 2007/0077418 (Sakurai et al.) discloses a pressure-sensitive adhesive composition, which comprises a cohesive component comprising a styrene-based block copolymer, and a basic component.

U.S. Pat. No. 6,352,784 (Katagiri) discloses a wood decorative material coated with resin composite film, comprising a laminate of a wood substrate; a heat bonding layer formed from a heat bonding resin composition comprising 100 parts by weight of a thermoplastic resin and 0.001 to 80 parts by weight of a tackifier resin; and a mar-proof surface layer. The heat bonding resin composition has a melting point or softening temperature of 170° C. or below and exhibits a melt flow rate (MFR) at 190° C. of 1 to 500 g/10 min.

PCT Publication No. WO/2002/020685 (Kreckel) discloses a pressure-sensitive adhesive tape comprising a backing bearing a pressure-sensitive adhesive layer. The backing comprises two or more layers. The exposed layer of the backing is a polymer layer. The polymer has a Vicat™ softening point of less than 65° C., for increasing the stability of a stack of goods comprising two or more superimposed layers of goods.

### SUMMARY

Edgebanding tapes are used in the manufacture of furniture to finish the edges of boards and, preferably wooden boards. Such boards include engineered wooden boards such as particleboard, chipboards and MDF. In order to be suitable for this use, edgebanding tapes preferably meet at least one of, and preferably each of, the following criteria: they are preferably flexible, for example sufficiently flexible so as to be wound on a spool, and to conform to any curved edges of the boards; capable of adhering to the boards, for example using hot melt adhesives; have a high surface hardness; are suitable for extrusion to produce a 3-dimensional tape as opposed to tape having a thickness less than 0.5 mm; can be made in a suitable thickness; and are suitable for decoration, such as by hot stamping, to give the appearance of a wood grain pattern.

Typical edgebanding tapes are made from semi-rigid polyvinylchloride (PVC), which meets the above criteria. However, poisonous gases such as phosgene are released when PVC burns. Moreover, phthalates are used to make PVC semi-rigid, and phthalates are health hazard. Therefore, PVC is a hazard and is both dangerous and environmentally unsafe. Attempts have been made to manufacture edgebanding tapes from other compounds. However, such tapes have not met the above criteria. For example, edgebanding tapes based on polyolefins or acrlonitrile butadiene styrene (ABS) are not suitably flexible, and require the application of special primers.

The present disclosure provides an edgebanding tape, which is made from a copolymer of ethylene and acrylic or methacrylic acid. The edgebanding tape meets the above criteria, and further, does not pose the health and environmental dangers of PVC.

According to one aspect, a furniture component is provided. The furniture component comprises a board having at least one edge. An edgebanding strip is secured to the at least one edge. The edgebanding strip comprises a copolymer of ethylene and acrylic or methacrylic acid.

The edgebanding strip may comprise at least one additive and may have a density greater than the density of water.

The edgebanding strip may comprise an inner surface secured to the at least one edge, and the inner surface may be surface activated. The edgebanding strip may comprise an outer surface opposed to the inner surface, and the outer surface may comprise a pattern.

The edgebanding strip may be secured to the at least one edge with an adhesive. Alternately, the edgebanding strip may be secured to the at least one edge by fusion.

The edgebanding strip may have a thickness of at least 0.5 mm, and may have at least one of the following properties:

a) a tensile strength of 10-30 MPa;

b) an elongation at break of 100-400%;

c) a modulus of elasticity in tension of 150-350 Mpa;

d) a surface hardness by shore scale of D 40-70 scale units; and,

e) a pencil hardness of at least BB.

The edgebanding strip may have a thickness of at least 3 mm.

The copolymer of ethylene and acrylic or methacrylic acid may be sodium or zinc ionomer thermoplastic resin.

The strip may be selected from one or more of a corona treated strip, plasma treated strip, a laser treated strip, and an open flame treated strip.

The edgebanding strip may comprise a copolymer of ethylene and methacrylic acid.

According to another aspect, a process for finishing a board useable in the manufacture of furniture is provided. The process comprises
a) providing an edgebanding strip of a copolymer of ethylene and acrylic or methacrylic acid that has been subjected to a surface adhesion enhancement treatment; and
b) securing the strip to an edge of the board.

The surface adhesion enhancement treatment may comprise at least one of a corona treatment, a plasma treatment, a laser treatment, and an open flame treatment.

The strip may comprise an outer finished surface and an inner surface, and the surface treatment may be applied to the inner surface.

The process may further comprise storing the strip prior to carrying out step (b). The strip may be stored for up to 6 months.

Step (a) may comprise extruding the copolymer of ethylene and acrylic or methacrylic acid. The extrusion may comprise a screw extrusion.

Step (a) may comprise blending the copolymer with at least one additive prior to forming the strip. The process may further comprise selecting the additive from at least one of a colorant and a density modifier. An amount of density modifier may be added to increase the density of the strip to be greater than that of water.

Step (a) may comprise applying a pattern to the outer finished surface of the strip. The pattern may be applied by at least one of hot stamping and printing. The process may comprise applying a wood-grain pattern.

Step may (b) comprise: applying an adhesive to at least one of an inner surface of the edgebanding strip and the edge of the board; and, applying the edgebanding strip to the edge of the board. Step (b) may alternately comprise: applying heat to an inner surface of the edgebanding strip; and fusing the edgebanding strip to the edge of the board.

The edge of the board may comprise a curved portion, and step (b) may comprise flexing the strip to conform to the curved portion.

The board may be incorporated into a piece of furniture.

Step (a) may comprise selecting the strip to have a thickness of about 0.5 mm or greater. Preferably, the method comprises selecting the strip to have a thickness of about 3 mm or greater.

Step (a) may comprise selecting as the copolymer a sodium or zinc ionomer thermoplastic resin.

Step (a) may comprise selecting an edge banding strip of a copolymer of ethylene and methacrylic acid.

According to another aspect, an edgebanding tape is provided. The edgebanding tape comprises a surface activated strip comprising a copolymer of ethylene and acrylic or methacrylic acid having a thickness of 0.5 mm or greater.

The strip may be selected from one or more of a corona treated strip, plasma treated strip, laser treated strip, and an open flame treated strip.

The strip may have an inner surface that is surface activated. The strip may have an outer surface opposed to the inner face, and the outer surface may have a pattern applied thereto. The pattern may be a wood-grain pattern.

The strip may further comprise one or more additives. The additive may be a colorant or a density modifier. The density modifier may be added to increase the density of the strip and to greater than that of water.

The strip may have a thickness of 3 mm or greater.

The strip may be flexible.

The copolymer of ethylene and acrylic or methacrylic acid may be a sodium or zinc ionomer thermoplastic resin.

The strip may have a thickness of 0.5 mm or greater and a tensile strength 10-30 MPa. The strip may have an elongation at break of 100-300%, or even 100-400%. The strip may have modulus of elasticity in tension of 150-350 MPa. The strip may have a surface hardness by shore scale D of 40-50 or even 40-70 scale units. The strip may have a pencil hardness of at least B and preferably at least BB.

The strip may include color concentrates made on the same polymer base as the copolymer of ethylene and acrylic or methacrylic acid.

### DRAWINGS

Reference is made in the detailed description to the appended drawings, in which:

FIG. 1a is a perspective illustration of an example of a piece of furniture;

FIG. 1b is a top view of the region shown in circle 1b in FIG. 1a;

FIG. 1c is a cross section taken along line c-c in FIG. 1b; and,

FIG. 2 is a flowchart of an example of a process for finishing a board.

### DETAILED DESCRIPTION OF VARIOUS EXAMPLES

Various apparatuses or methods will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention.

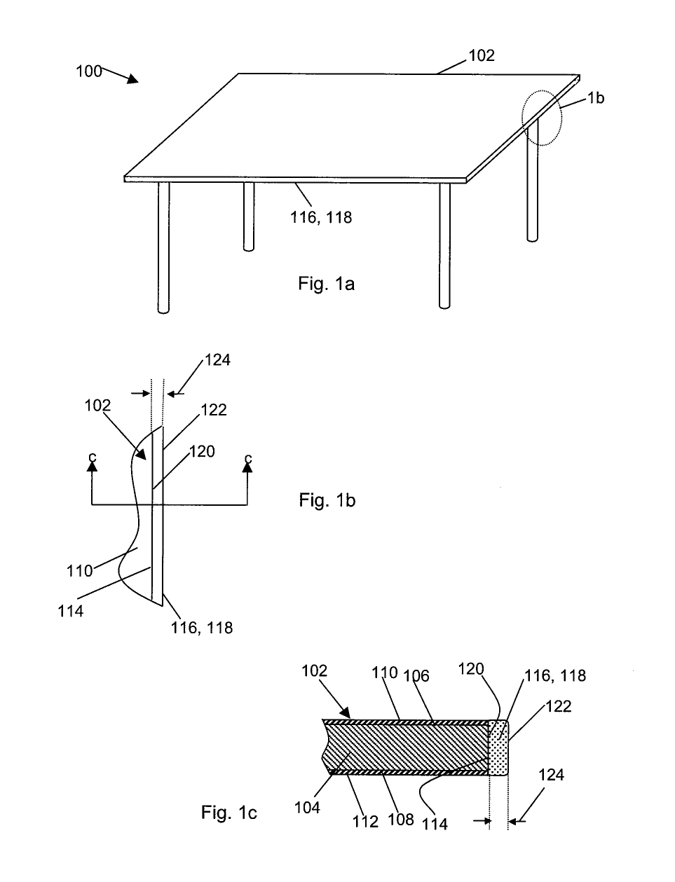

Referring to FIG. 1a, an example of a piece of furniture 100 is shown. In the example shown, the piece of furniture 100 is a table. In alternate examples, the piece of furniture may be any other piece of furniture, such as office furniture, or home furniture. For example, the piece of furniture may be a desk, a bed, a bookshelf, a chair, a dresser, or a bench. Preferably, the edge banding tape is used with any piece of furniture that has an outer surface that forms a portion of the outer surface of the piece of furniture and requires finishing.

Referring to FIGS. 1a to 1c, the piece of furniture 100 comprises at least one furniture component 102, which comprises a board 104 (shown in FIG. 1c). As exemplified, the furniture component 102 is a tabletop. In alternate examples, the furniture component may be, for example, a desktop, a shelf, a drawer, a shelf, a privacy panel, a sidewall or the like. The board 104 may be any suitable type of board, such as an engineered wood board. The engineered wood board may be, for example, fibre board, such as MDF, particle board, oriented strand board, plywood, a chipboard or other board that has a surface which can not be finished (e.g., sanded and varnished) to provide a suitable exterior surface for the piece of furniture. The board has first 106 and second 108 opposed faces. A first veneer 110 may be applied to the first surface 106, and/or a second veneer 112 may be applied to the second surface 108. Alternately, first and second surfaces 106, 108 may be suitable for being directly finished (e.g., plywood having a suitable outer surface).

Referring to FIG. 1c, the board further comprises at least one edge 114. In the example shown, as the table is generally rectangular, the board 104 comprises a plurality of edges 114. However, in alternate examples, such as a table, which maybe generally rounded, a board may have only one edge. An edgebanding tape 116 is secured to the edge 114. The edgebanding tape 116 generally comprises a strip 118 (also referred to herein as an ‘edgebanding strip’), which is secured to the edge 114. Specifically, the strip 118 comprises an inner surface 120, and an opposed outer surface 122 (also referred to herein as an outer finished surface 122). The inner surface 120 is secured to the edge 114. The strip 118 finishes the edge 114, as well as protects the edge 114.

As will be described in further detail hereinbelow, the strip 118 comprises a copolymer of ethylene and acrylic or methacrylic acid. For example, the copolymer may be a sodium or zinc ionomer thermoplastic resin. The strip 118 may optionally further comprise one or more additives that are commonly used in the art, such as a colorant or a density modifier. An advantage of these materials is that the strip 118 may be generally safe for use. For example, in a fire, the strip 118 may not release poisonous or environmentally harmful gases such as phosgene. Further, the strip preferably does not contain phthalates.

Strip 118 is preferably flexible. Preferably, strip 118 is sufficiently flexible to be wound on a spool, e.g., having a diameter of as little as 1 Ft, and to be unwound for use. For example, subsequent to being formed in an extrusion process (as will be described further hereinbelow), strip 118 may be wound on a spool. If the strip is not sufficiently flexible, it may still be wound on the spool if it is warm from the extrusion process. However, if it subsequently cools, it may be difficult to unwind, and when eventually unwound, may retain the curve of the spool. If the strip retains the curve of the spool, it may have a tendency to pull off of a board to which it is adhered. Accordingly, strip 118 is preferably sufficiently flexible to be wound on a spool, whether warm or at room temperature, and to be unwound from the spool without retaining the shape of the spool. Further, strip 118 is preferably sufficiently flexible so as to be able to conform to the edge to which it is to be attached. Accordingly, strip 118 is preferably able to conform to a curved edge 114 of the board 104. For example, the strip 118 may have a modulus of elasticity in tension of 60 to 100 MPa.

Alternately, or in addition, strip 118 is preferably capable of adhering to the edge 114 of the board 102 without mechanical fasteners. For example, the inner surface 120 of the strip 118 may optionally be surface activated to enhance the ability of the strip 118 to adhere to the edge 114, and may be securable to the edge 114 of the board 104 via chemical means, such as by an adhesive or by fusion. More preferably, the strip is capable of adhering to the edge 114 of the board 120 without the use of a primer. That is, known edgebanding tapes require the use of a primer to adhere to the edge of a board. Such primers typically include a blend of solvents, which are environmentally unfriendly. The edgebanding tape as disclosed herein may not require the use of such primers.

Alternately, or in addition, strip 118 is preferably generally strong and hard.

For example, the strip 118 may have at least one of the following properties and preferably each of the following properties: a surface hardness by shore scale D of 40 to 50+ scale units, a pencil hardness of at least B, an elongation at break of 100 to 300%, and a tensile strength of about 10 to 30 MPa.

Alternately, or in addition, the strip 118 may be made by extrusion, and may be made in a suitable thickness. For example, the strip 118 may have a thickness 124 of at least 0.5 mm, preferably greater than 1 mm, and most preferably, equal to or greater than 3 mm.

Alternately, or in addition, the strip 118 may be suitable for decoration, such as by hot stamping or printing of the outer surface 122, to give the outer surface 122 a pattern, such as a wood grain pattern.

Alternately, or in addition, the strip 118 may be capable of being stored. For example, after a surface activating treatment, the strip 118 may be stored for up to 6 months prior to being secured to the edge 114 of the board 104.

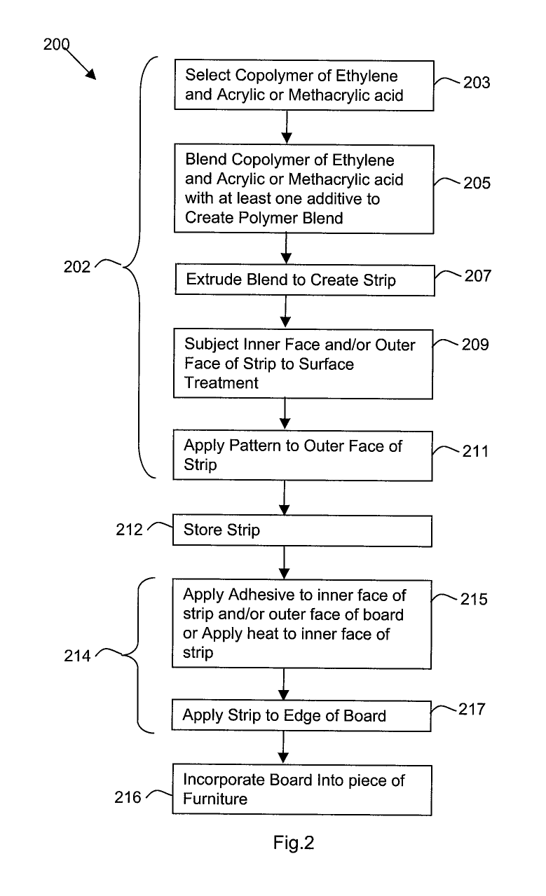

Referring to FIG. 2, an example of a process for finishing a board is shown. The process will be described with reference to board 104 and strip 118. However, it will be appreciated that the process 200 may be used for finishing any other suitable type of board, and a strip other than strip 118 may be used. The process 200 generally comprises a step of providing an edgebanding strip 118 of a copolymer of ethylene and acrylic or methacrylic acid (step 202), and securing the strip 118 to the edge 114 of a board 104 (step 214). Preferably, the strip 118 that is provided in step 202 has been subjected to a surface adhesion enhancement treatment (also referred to herein as a surface treatment).

Referring still to FIG. 2, step 202 may optionally comprise a first step of selecting a copolymer of ethylene and acrylic or methacrylic acid (step 203). Preferably, the selected copolymer of ethylene and acrylic or methacrylic acid (referred to hereinafter as “the copolymer”) is a zinc or sodium ionomer thermoplastic resin (i.e. a copolymer in which the acrylic or methacrylic acid groups have been neutralized with zinc (e.g. Surlyn® 9970 sold by Dupont™) or sodium (e.g. Surlyn® 8120, or Surlyn®8020, both sold by Dupont™) ions). For example, if a copolymer of ethylene and methacrylic acid is selected, the copolymer may be any of those sold by DuPont™ under the name Surlyn®, such as Surlyn® 9950, Surlyn® 9910, Surlyn® 8120, Surlyn® 8020, Surlyn® 9970. Alternately, the copolymer of ethylene and methacrylic acid may be one of those sold by Arkema under the name Lotryl®. Alternately, the copolymer of ethylene and methacrylic acid may be Elvaloy® 1209 or Elvaloy® 1218 sold by DuPont. Alternately, if a copolymer of ethylene and acrylic acid is selected, the copolymer may be one of those sold by Dow Chemicals under the name Primacor® or by DuPont under the name Nucrel®

Step 202 may further optionally comprise a step of blending the copolymer with at least one additive (step 205). The additives may include other polymers, such as low and/or high-density polyethylene. The additives may additionally or alternately include one or more colorants. Preferably, the colorant includes a color concentrate made on the same polymer base as the copolymer. The additives may additionally or alternately include one or more fillers. The fillers preferably include one or more density modifiers, such as barium sulfate, calcium carbonate, talc, and dolomites. The density of some copolymers of ethylene and acrylic or methacrylic acid is less than the density of water. For example, Surlyn® 9910 has a density of 0.97 g/cm³. Due to this density, if Surlyn® 9910 is extruded, it will float on the surface of any water cooling baths, and may not properly cool to form the desired product. Accordingly, density modifiers may be added to increase the density of the blend to greater than the density of water, so that during extrusion, the product will not float on the surface of any cooling baths. Accordingly, fillers may improve the processability and/or colour of the copolymer. The additives may additionally or alternately include additives to modify the surface hardness of the strip. Such additives may include Irgasurf® SR100 sold by Ciba®.

In order to blend the copolymer with the additives, a standard extruder may be equipped with a mixing tank. Preferably the mixing tank is installed upstream of the first heating stage on the extruder. The proportion of feedstock that is added to the mixing tank may be metered using gravity or volume and all components may be mechanically blended in the mixing tank as pellets at ambient temperature.

The copolymer may comprise between 100 wt. % and 60 wt. %, preferably between 95 wt. % and 85 wt. %, and more preferably between 95 wt. % and 90 wt. % of the polymer blend. If one or more additional polymers are provided, the additional polymer may comprise between 10 wt. % and 40 wt. %, preferably between 10 wt. % and 20 wt. %, and more preferably between 10 wt. % and 15 wt. % of the polymer blend. If one or more fillers are provided, the fillers may comprise between 5 wt. % and 40 wt. %, preferably between 10 wt. % and 30 wt. % and more preferably between 10 wt. % and 20 wt. % of the polymer blend. If one or more colorants are provided, the colorants may comprise between 1 wt. % and 10 wt. %, preferably between 2 wt. % and 8 wt. % and more preferably between 2 wt. % and 4 wt. % of the polymer blend. If Irgasurf® SR100 is used for surface hardness modification, it may comprise between 1 wt. % and 10 wt. %, preferably between 1 wt. % and 5 wt. %, and more preferably between 2 wt. % and 3 wt. % of the polymer blend. In one specific example, the polymer blend may comprise 26.1 wt. % high density polyethylene (HDPE), 65.9 wt. % Surlyn® 8020, 5.0 wt. % calcium carbonate, and 3.0 wt. % Irgasurf® SR100.

Step 202 may further comprise a step of extruding the copolymer, or, more specifically, extruding the blend to create the strip 118 (step 207). The extrusion step preferably uses single screw-extrusion, however, any extruder may be used. In one example, a single screw extruder made by Davis-Standard® may be used. The extruder preferably has four heating zones with the barrel temperatures of first zone between 190° C. and 195° C., the barrel temperatures of the second and third zones between 200° C. and 205° C., and the barrel temperature of the fourth zone between 205° C. and 210° C. The clamp temperature may be between 160° C. and 170° C., and the clamp pressure may be 750 psi. The extruder speed may be 22-28 RPM. To produce a strip 118 having a thickness of 3 mm, a calibrated die may be installed at the head of the extruder with a temperature controlled at between 165° C. and 170° C. Preferably, to control uniformity of the thickness and the width of the strip 118, the puller speed is selected at 18 ft/min. Using these parameters, it may be possible to produce an edgebanding tape with width (i.e. from the upper surface to the lower surface) of 29 mm and a thickness of 3 mm.

The die used in the extrusion is preferably configured to give the strip 118 a particular thickness and shape or profile. That is, the step of extruding the copolymer may include selecting a particular thickness 124 for the strip 118. Preferably, the thickness 124 of the strip 118 is selected to be at least 0.5 mm, more preferably at least 1.0 mm, and most preferably at least 3.0 mm. The thickness may be up to 5 mm. Further, the die is preferably shaped so that the strip 118 has an inner surface 120, and an opposed outer surface 122, as described hereinabove with respect to FIG. 1. The inner and outer surface 120 are preferably flat, however it is possible that the outer surface 122 is rounded.

After extruding the blend to create the strip 118, step 202 may further comprise a step of subjecting the strip 118, and more specifically, one or both of the inner surface 120 and outer surface 122 of the strip 118, to a surface treatment (step 209). The surface treatment for inner surface may be any suitable treatment that enhances the ability of the strip 118 to adhere to an edge of the board 104. In a preferred embodiment, the surface treatment increases the ability of the inner surface 120 to be bonded to and edge 114 by an adhesive. For example, the surface enhancement treatment of the inner surface may include one or more of a corona treatment, a plasma treatment, a laser treatment, and an open flame treatment. The surface treatment for the outer surface may be any suitable treatment that enhances the ability of the outer surface to have a pattern applied thereto. For example, the surface enhancement treatment of the outer surface preferably includes one or more of corona treatment, plasma treatment and open flame treatment. Standard equipment exists for each type of the treatment. In one specific example, Corotec plasma jet Model PJ-2 with two surface treating heads may be used. The upper head may treat the outer surface and the bottom head may treat inner surface of the tape. After surface treatment, the strip 118 may also be referred to as a surface treated strip 118.

After subjecting the strip 118 to the surface treatment (step 209), a pattern may be applied to the outer surface 122 of the strip (step 211). Any suitable pattern may be applied. Preferably, the pattern is a wood-grain pattern. The pattern may be applied in any suitable fashion, such as by printing or hot stamping.

The steps (i.e. steps 203 to 211) included in the step of providing the edgebanding strip (i.e. step 202) are preferably carried out in a continuous fashion. However, they may alternately be carried out in a batch fashion, or a semi-continuous fashion. They may be carried out immediately after each other or one or more of the individual sub-processes (i.e. steps 203 to 211) may be carried out and the product stored until one or more of the additional steps is carried out.

After providing the edgebanding strip (step 202), the edgebanding strip 118 may optionally be stored (step 212) prior to securing the strip 118 to the edge 114 of the board 104 (i.e. step 214). For example, the edgebanding strip 118 may be rolled into a roll (e.g. on a spool), and stored. Unexpectedly, using copolymers of ethylene and acrylic or methacrylic acid to form the strip 118, and subjecting the strip 118 to a surface treatment to enhance the surface adhesion properties of the strip 118, the surface of the strip 118 may remain sufficiently adherable, even after storage for an extended period of time. For example, the edgebanding strip 118 may optionally be stored for up to 6 months, and may remain adherable even after storage for 6 months. Accordingly, the strip 118 may be prepared and stored. Subsequently, a roll of edgebanding tape may be shipped, or used in a factory to manufacture furniture. Alternately, the edgebanding strip 118 may be used immediately after it is formed.

At step 214, the strip is secured to the edge 114 of a board 104. This is preferably done by using an edgebanding machine, as is known in the art. Examples of suitable edgebanding machines include those sold by HOMAG AG or IMA. Specifically, the edgebanding machine may apply an adhesive to one or both of the inner surface 120 of the strip 118 and the edge 114 of the board 104 (step 215). Preferably, the adhesive is applied to the edge 114 of the board 118. The adhesive may be any suitable type of adhesive, and is preferably a hot melt adhesive, more preferably a hot melt moisture-cured adhesive. Such adhesives are sold by the Jowat Corporation, H.B. Fuller, Henkel, Forbo Group and many others. The edgebanding machine may then apply the strip 118 to the edge 114 of the board 104 (step 217). For example, the strip 118 may be pressed continuously against the adhesive as the board 104 travels. If the edge 114 of the board comprises a curve or curved portion, as shown in FIG. 1, the strip 118 may flex to conform to the curve or curved portion. The strip 118 may be heated as required for this step.

In an alternate example, the strip 118 may be fused to the edge 114 of the board 104. For example, heat may be applied to the inner surface 120 of the strip 118, and the strip 118 may be fused to the edge 114 of the board 104.

Preferably, the strip 118 is secured to the edge of the board without the use of a primer, as mentioned hereinabove.

In an alternate example, the strip 118 may be secured to the edge 114 of the board 104 manually.

After the strip 118 is secured to the board 104, the ends of the strip 118 may be cut and buffed.

The board may then be incorporated into a piece of furniture (step 218), such as the piece of furniture 100 shown in FIG. 1. Alternately, the strip may be applied to a completed piece of furniture.

### EXAMPLES

### Example 1

An edge banding tape was prepared comprising: 29.1 wt % HDPE, 67.9 wt % Surlyn® 8020 and 3 wt % IrgasurfSR100. These feed materials were blended and then extruded using a single screw extruder with an L/D Ratio of 20 and 4 heating zones with temperatures of the zones from 185° C. to 210° C. A 3 mm thick strip was produced with a tensile strength of 23.5 MPa; an elongation at break of 300%; a Shore D hardness of 42.5 scale units; and a modulus of elasticity of 300 MPa.

### Example 2

An edge banding tape was prepared comprising 48 wt % Surlyn® 9910, 48 wt % Surlyn® 9950, 2 wt % calcium carbonate and 2 wt % color concentrate 2 wt %. These feed materials were blended and then extruded on a Davis—Standard® single screw extruder with four heating zones, with the barrel temperatures on first zone at 188-191° C., the barrel temperatures on the second and third zones temperature at 195° C.-200° C., and the barrel temperatures on fourth zone at 210° C.-218° C. The clamp temperature was at 170° C.-180° C., and the clamp pressure was 850 psi. The extruder speed was 22-28 RPM. A calibrated die was used with a temperature that was controlled from 165° C. to 170° C. The resulting strip had a thickness of 3 mm; a tensile strength of 23 Mpa; a modulus of elasticity of 265 Mpa; an elongation at break of 300%; and a surface hardness of Shore D 60.

Immediately after extrusion, the strip was corona treated using a Corotec plasma jet Model PJ-2 with two surface treating heads. After the surface treatment, a wood grain pattern was hot stamped onto outer surface of the strip, and the edgebanding tape was rolled on a spool for storage. During the storage, the edgebanding tape was tested for retaining its adhesivity. Specifically, every month, the edgebanding tape was removed from storage and adhered to particle board on a Homag KL 78-83-S2 edgebanding machine using Forbo PUR 534 Ever-Lok adhesive at temperatures of 170° C.-180° C. The strip had excellent adhesion even after 6 months of storage.

1. A furniture component comprising:
a) a board having at least one edge;
b) an edgebanding strip secured to the at least one edge, the edgebanding strip comprising a copolymer of ethylene and acrylic or methacrylic acid.

2. The furniture component of claim 1, wherein the strip comprises at least one additive and has a density greater than the density of water.

3. The furniture component of claim 1, wherein the edgebanding strip comprises an inner surface secured to the at least one edge, and the inner surface is surface activated.

4. The furniture component of claim 3, wherein the edgebanding strip comprises an outer surface opposed to the inner surface, and the outer surface comprises a pattern.

5. The furniture component of claim 1, where in the edgebanding strip is secured to the at least one edge with an adhesive.

6. The furniture component of claim 1, wherein the edgebanding strip is secured to the at least one edge by fusion.

7. The furniture component of claim 1, wherein the edgebanding strip has a thickness of at least 0.5 mm and has at least one of the following:
a) a tensile strength 10-30 MPa;
b) an elongation at break 100-400%;
c) a modulus of elasticity in tension 150-3500 Mpa;
d) a surface hardness by shore scale D 40-70 scale units; and,
e) a pencil hardness at least BB.

8. The furniture component of claim 1, wherein the copolymer of ethylene and acrylic or methacrylic acid is sodium or zinc ionomer thermoplastic resin

9. The furniture component of claim 1, wherein the edgebanding strip has a thickness of at least 3 mm.

10. The furniture component of claim 1, wherein the strip is selected from one or more of a corona treated strip, plasma treated strip, a laser treated strip, and an open flame treated strip.

11. The furniture component of claim 1, wherein the edgebanding strip comprises a copolymer of ethylene and methacrylic acid.

12. A process for finishing a board useable in the manufacture of furniture comprising:
a) providing an edge banding strip of a copolymer of ethylene and acrylic or methacrylic acid that has been subjected to a surface adhesion enhancement treatment; and,
b) securing the strip to an edge of the board.

13. The process of claim 12, wherein the surface adhesion enhancement treatment comprises at least one of a corona treatment, a plasma treatment, a laser treatment, and an open flame treatment.

14. The process of claim 12, wherein the strip comprises an outer finished surface and an inner face, and the surface treatment has been applied to the inner face.

15. The process of claim 12, further comprising storing the strip prior to carrying out step (b).

16. The process of claim 15, wherein the strip is stored for up to 6 months.

17. The process of claim 12, wherein step (a) comprises extruding the copolymer of ethylene and acrylic or methacrylic acid.

18. The process of claim 17, wherein the extrusion comprises a screw extrusion.

19. The process of claim 12, wherein step (a) comprises blending the copolymer with at least one additive prior to forming the strip.

20. The process of claim 19, further comprising selecting the additive from at least one of a colorant and a density modifier.

21. The process of claim 20, wherein an amount of density modifier is added to increase the density of the strip to be greater than that of water.

22. The process of claim 12, wherein step (a) comprises applying a pattern to the outer finished surface of the strip.

23. The process of claim 22, wherein the pattern is applied by at least one of hot stamping and printing.

24. The process of claim 22, further comprising applying a wood-grain pattern.

25. The process of claim 19, wherein step (b) comprises:
a) applying an adhesive to at least one of an inner surface of the edgebanding strip and the edge of the board; and,
b) applying the edgebanding strip to the edge of the board.

26. The process of claim 12, wherein step (b) comprises:
a) applying heat to an inner surface of the edgebanding strip; and
b) fusing the edgebanding strip to the edge of the board.

27. The process of claim 12, wherein the edge of the board comprises a curved portion, and step (b) comprises flexing the strip to conform to the curved portion.

28. The process of 12, wherein the board is incorporated into a piece of furniture.

29. The process of claim 23, wherein step (a) comprises selecting the strip to have a thickness of about 0.5 mm or greater.

30. The process of claim 12, wherein step (a) comprises selecting the strip to have a thickness of about 3 mm or greater.

31. The process of any of claim 12, wherein step (a) comprises selecting as the copolymer a sodium or zinc ionomer thermoplastic resin.

32. The process of claim 12, wherein step (a) comprises selecting an edge banding strip of a copolymer of ethylene and methacrylic acid

33. An edgebanding tape made by the process of claim 12.

34. An edgebanding tape comprising a surface activated strip comprising a copolymer of ethylene and acrylic or methacrylic acid having a thickness of 0.5 mm or greater.

35. The edgebanding tape of claim 34, wherein the strip is selected from one or more of a corona treated strip, plasma treated strip, laser treated strip, and an open flame treated strip.

36. The edgebanding tape of claim 34, wherein the strip has an inner surface that is surface activated.

37. The edgebanding tape of claim 36, wherein the strip has an outer surface opposed to the inner face, and the outer surface has a pattern applied thereto.

38. The edgebanding tape of claim 37, wherein the pattern is a wood-grain pattern.

39. The edgebanding tape of claim 34, wherein the strip further comprises one or more additives.

40. The edgebanding tape of claim 39 wherein the additive is a colorant or a density modifier.

41. The edgebanding tape of claim 40, wherein the density modifier is added to increase the density of the strip and to greater than that of water.

42. The edgebanding tape of claim 34, wherein the strip has a thickness of 3 mm or greater.

43. The edgebanding tape of claim 34, wherein the strip is flexible.

44. The edgebanding tape of claim 34, wherein the copolymer of ethylene and acrylic or methacrylic acid is a sodium or zinc ionomer thermoplastic resin.

45. The edgebanding tape of claim 34, wherein the strip has a thickness of 0.5 mm or greater and tensile strength 10-30 MPa.

46. The edgebanding tape of claim 34, wherein the strip has an elongation at break of 100-400%.

47. The edgebanding tape of claim 34, wherein the strip has modulus of elasticity in tension of 150-350 MPa.

48. The edgebanding tape of claim 34, wherein the strip has a surface hardness by shore scale D of 40-70 scale units.

49. The edgebanding tape of claim 34, wherein the strip has a pencil hardness at least BB.

50. The edgebanding tape of claim 34, wherein the strip includes a color concentrates made on the same polymer base as the copolymer of ethylene and acrylic or methacrylic acid.

51. An engineered wood board using the edgebanding tape of claim 34.
